(19) United States
(12) Patent Application Publication
(10) Pub. No.: US 2021/0299952 A1
(43) Pub. Date: Sep. 30, 2021

(54) ROLLER-MEMBRANE LAYERING MICRO STEREOLITHOGRAPHY

(71) Applicant: BMF MATERIAL TECHNOLOGY INC., Shenzhen (CN)

(72) Inventors: Chunguang XIA, San Diego, CA (US); Liangkang FU, Shenzhen (CN)

(21) Appl. No.: 17/207,090

(22) Filed: Mar. 19, 2021

Related U.S. Application Data
(60) Provisional application No. 62/994,347, filed on Mar. 25, 2020.

(51) Int. Cl. B29C 64/135; B33Y 10/00; B33Y 30/00; B33Y 50/02; B29C 64/393; B29C 64/264; B29C 64/218; B29C 64/245

(52) U.S. Cl. CPC B29C 64/135; B33Y 10/00; B33Y 30/00; B29C 64/245; B29C 64/393; B29C 64/264; B29C 64/218; B33Y 50/02

(57) ABSTRACT

The speed and control over layer thickness in multi-layer 3-D printing is enhanced when producing a sample layer by projecting an image of the layer from light engine onto an optically clear membrane in contact with a printing material to prepare a sample layer in contact with the membrane, followed by moving the sample away from the membrane to separate the two, then moving the sample back toward the membrane to a point where the distance between the membrane and sample, as measured by a laser displacement sensor, is equal to the thickness of the next layer. While the sample moves back toward the membrane a dual-roller spreader or rotary roller spreader oscillates on the membrane to simultaneously to drive away printing material and flatten the membrane. A bubble scrapper is employed to remove bubbles from the printing material as they form.

The present invention provides an improved method for faster printing over a larger-area with printing materials of a broader viscosity range, e.g., typically light curable resins have a viscosity up to 30,000 cPs, without sacrificing the resolution available from existing micro stereolithography methods, a 3D printing technology. For example, many present embodiments combine a dual-roller spreader with an optically clear, i.e., optically transparent, membrane, which quickly defines a very thin layer of printing materials, e.g., resins, during large-area printing. The method of the invention disclosed herein is not limited to projection type of micro 3D printing methods using DLP or LCD; it is also valid for any other type of method using laser beam/spot scanning to define the shape of solid layer in 3D printing.

### BACKGROUND OF THE INVENTION

Stereolithography was originally conceived as a rapid prototyping technology. Rapid prototyping refers to a family of technologies that are used to create true-scale models of production components directly from computer aided design (CAD) in a rapid (faster than before) manner. Since its disclosure in U.S. Pat. No. 4,575,330, stereolithography has greatly aided engineers in visualizing complex three-dimensional part geometries, detecting errors in prototype schematics, testing critical components, and verifying theoretical designs at relatively low costs and in a faster time frame than before.

During the past decades, continuous investments in the field of micro-electro-mechanical systems (MEMS) have led to the emergence of micro-stereolithography (μSL), which inherits basic principles from traditional stereolithography but with much higher spatial resolution e.g., K. Ikuta and K. Hirowatari, “Real three dimensional micro fabrication using stereo lithography and metal molding,” 6th IEEE Workshop on Micro Electrical Mechanical Systems, 1993. Aided by single-photon polymerization and two-photon polymerization techniques, the resolution of μSL was further enhanced to be less than 200 nm, e.g., S. Maruo and K. Ikuta, “Three-dimensional microfabrication by use of single-photon-absorbed polymerization,” Appl. Phys. Lett., vol. 76, 2000; S. Maruo and S. Kawata, “Two-Photon-Absorbed Near-Infrared Photopolymerization for Three-dimensional Microfabrication,” J. MEMS, vol. 7, pp. 411, 1998; S. Kawata, H. B. Sun, T. Tanaka and K. Takada, “Finer features for functional microdevices,” Nature, vol. 412, pp. 697, 2001.

The speed was dramatically increased with the invention of projection micro-stereolithography (PμSL), Bertsch et al., “Microstereophotolithography using a 1997; Beluze et al., “Microstereolithography: a new process to build complex 3D objects , Symposium on Design, Test and microfabrication of MEMs/MOEMs”, Proceedings of SPIE, v3680, n2, p808-817,1999. The core of this technology is a high resolution spatial light modulator, which is either a liquid crystal display (LCD) panel or a digital light processing (DLP) panel, each of which are available from micro-display industries.

While PμSL technology has been successful in delivering fast fabrication speeds with good resolution, further improvements are still wanted.

There are three types of resin layer definition methods in PμSL: the first uses a free surface where the layer thickness is defined by the distance between the resin free surface and the sample stage. Due to the slow viscous motion of resins, when the printing area is larger than 1 cm×1 cm, it takes more than half hour to define a 10 um thick resin layer having a viscosity of 50 cPs. The second and the third methods use either a transparent membrane or a hard window. Again, for both cases, as for the first method previously described, there is currently no good method for defining 10 um or thinner resin layers over an area of 5 cm×5 cm or larger, especially for the membrane case, because even if it is faster than the free surface case, it is still impractically slow. As for the hard window case, the fluidic dynamic force created as the sample closes in to define the thin layer before exposure or during the separation after exposure is big enough to damage the samples.

In this invention a new method combines the action of a roller spreader with a clear membrane to overcome the difficulty of defining a very thin layer (<20 um) of printing material over an area of 10 cm×10 cm.

In all 3D printing technologies, accuracy and efficiency in dimension replication is very important. Therefore, in the roller-membrane layering μSL systems (FIG. 1) of the invention, it is very important to have high accuracy and efficiency in dimension control for all layers, so that the actual CAD model can be duplicated in a practical period of time.

### SUMMARY OF THE INVENTION

The method of the present invention provides more precise control, with greater speed and accuracy in layer thickness in a larger printing area, for example, 10 cm×10 cm printing area with 5-20 um layer thickness. In one broad embodiment, the present method uses a dual-roller spreader combined with a clear membrane. The method not only maintains the dimensional accuracy of samples printed using, e.g., PμSL systems, but also significantly improves the printing speed by combining the roller spreader with a clear membrane during the thin layer coating process. Printing materials as used herein refer to materials, typically resins, e.g. light curable resins or their mixtures with solid particles, that are used in the industry to print and cure in constructing layers in 3-D printing operations.

The roller spreader of the invention can have has at least one roller which is typically made of metal or ceramic for rigidity and accuracy. Often, in the present invention, a dual-roller spreader with two parallel rollers is designed for a better spreading efficiency is used. An optically clear membrane of 50 um to 100 um thick, isolates the rollers from the printing material improving the speed and layering accuracy. The roller surface can be covered with silicone or rubber of 50 to 100 um thick to increase slide resistance on the membrane and to protect the membrane. The invention is not limited to the use of a linear spreader that oscillates in a single direction as in many dual-roller embodiments, in some embodiments, for example, it has been found that a rotary spreader with differential mechanism is also a valid design.

For example, in many embodiments, the invention makes use of a system comprising: i) an optical light engine, it can be a DLP or LCD with a light source for projection micro stereolithography or a laser beam with steering mirrors for stereolithography (SLA), ii) a lens having an optical axis with an electromagnetic coil jacket to create a magnetic field at the printing area, iii) A dual-roller linear spreader or a rotary spreader on top of the membrane for layering, iv) A bubble scrapper with a silicone tip, v) three precision stages to control the motion of the substrate for supporting the printing sample or the printing projection system in the X, Y, and Z directions, vi) a resin vat under the membrane where the parts are printed and vii) a laser displacement sensor for checking monitoring the membrane position and the printing substrate position to ensure one micron accuracy. The system is arranged relative to a surface of a substrate, i.e., sample holder, or sample so that the lens is situated between the surface of the substrate and the light engine and it is gravitationally above the substrate.

In one embodiment, with the aid from the XY stages, in a configuration for PμSL, this invention provides three printing modes. When only a single sample needed, which is smaller than the single exposure size, it is called single exposure mode. If multiple samples are needed, the XY stages will move stepwise and print the same sample in an array, which is called array exposure mode. As the sample size increases to exceed the size of the single exposure, the system will further divide one layer into multiple sections and stitch the adjacent sections into a whole layer by overlapping 5 um to 20 um on the shared edges. This is the stitching exposure mode. It is also possible to combine the stitching mode with array mode.

In another embodiment of the invention, the interpolated offset error curves based on the measured data from actual samples will be fed into the translation of the XY stages to compensate the mechanical tolerances to ensure the accuracy of the stitching-printed sample is within the specifications.

In some embodiments, an electromagnetic coil is coaxial with the projection lens to control of the strength and orientation of the magnetic field at the wet surface of the membrane, in order to define and program the orientation of the magnetic dipoles in 3D micro scale.

### BRIEF DESCRIPTION OF THE DRAWINGS

FIG. 1 is a schematic drawing of the roller-membrane layering micro stereolithography system.

FIG. 2 is a dual-roller spreader design in the roller-membrane system.

FIG. 3 is a schematic drawing of the dual-roller on membrane system.

FIG. 4 shows the schematic drawing of the bubble scrapper in the roller-membrane layering μSL system.

FIG. 5 is a schematic drawing of the rotary-roller on membrane system.

FIG. 6, shows the steps of 3D magnetic sample printing in the roller-membrane layering μSL system

FIG. 7, shows the printing sequence for a 3D magnetic sample in the roller-membrane layering micro stereolithography system

FIG. 8 illustrates stitching errors in x and y direction during the stitch printing in the roller-membrane layering μSL system.

FIG. 9 shows the three printing modes in the roller-membrane layering μSL system.

### DESCRIPTION OF THE INVENTION

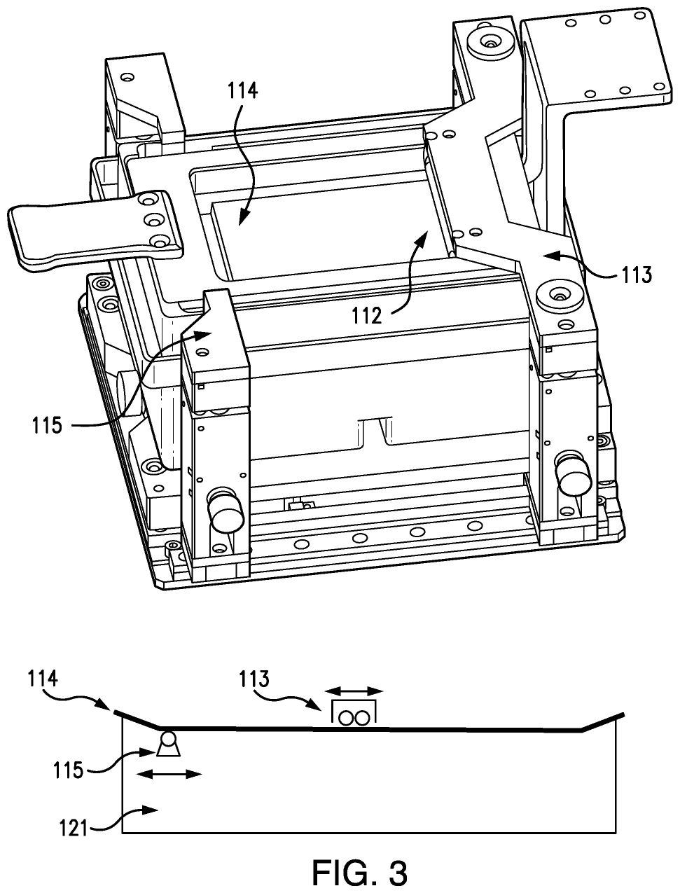

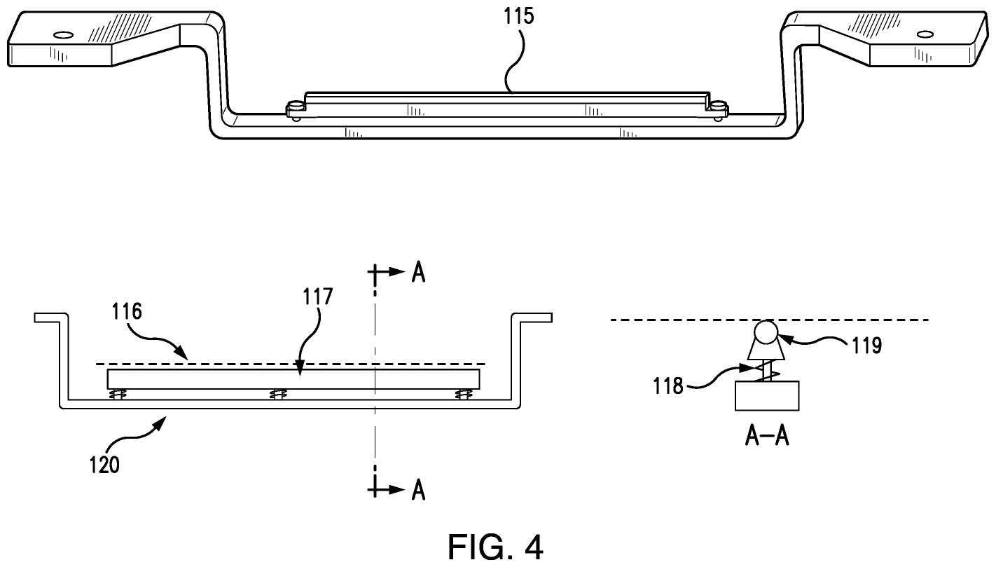

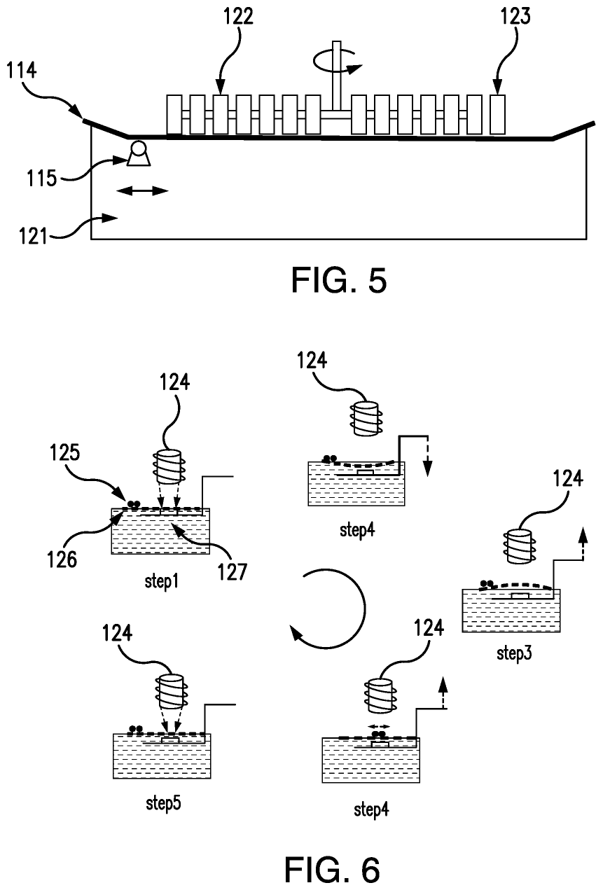

In one embodiment of the invention, the method is aided by a dual-roller spreader as in FIG. 2, e.g., as part of the light engine/spreader/membrane/displacement system discussed above. Rollers can be made of metals or ceramic to maintain rigidity during the rolling and spreading process on the membrane. At the same time the metal or ceramic helps to hold the precise tolerance (less than 10 um) on the dimensions. Dual rollers having a diameter of 6 mm with a gap of 500 um and 104 mm long can be used to cover a 100 mm×100 mm printing area. Metals or ceramics are much harder than the membrane, usually PFA (PerFluoroAlkoxy) or FEP (Polyfluoroethylenepropylene), therefore the rollers can cause damage to the surface, and thus reduce the optical clarity, i.e., optical transparency, of the membrane. To protect the membrane surface during the frequent rolling steps, the outer diameter of the roller is covered with a silicone or rubber skin of 50 um-100 um thick. The protective skin is either a radially stretched tube or formed during a coating process, for example dip-coating. The skin also significantly increases the friction coefficient between the roller and the membrane. Furthermore, the rollers 109 are fixed to the roller arm 110 by bearings 111, e.g., four 5 mm-diameter bearings. The rubber skin and the bearings guarantee that the rollers only roll on the membrane, without sliding and scratching. When the membrane 114 pops up due to the lifting of the substrate to define a new layer, the linear dual-roller spreader 113 oscillates over the sample to flatten the deformation of the membrane 114 (FIG. 3). The roller squeezes the printing material under the membrane and creates a high pressure at the rolling front, thereby creating a pressure gradient which drives the printing material in between the sample and membrane away from the gap. The pressure gradient is near proportional to the rolling speed of the roller and the viscosity of the printing material. The dual-roller design doubles the rolling frequency versus using single roller increasing the efficiency of the inventive method. As the printing happens at ambient pressure, it is inevitable that the air dissolves into the printing material. This dissolved air is very likely to be released and forms tiny bubbles during the printing due to either the mechanical movements of the substrate and membrane or the temperature change of the printing material. These tiny bubbles accumulate under the membrane due to the buoyancy and eventually merge into bigger bubbles. These bigger bubbles can cause the printing process to fail. Therefore, in the present invention, a bubble scrapper 115 is introduced (FIG. 4) to remove the tiny bubbles as they form. The scrapper 115 has a trench-shaped arm supporting a scrapper blade 117. The tip of the blade in one embodiment is mounted with a 1.5 mm diameter silicone band. The tip is pushing against the membrane by, e.g., 500 um, and slides against it to remove the bubbles. The printing material, e.g., resin, acts as lubricant and the flexibility of silicone together protect the optical finish of the membrane. Further, the blade 117 is spring-loaded to the arm to make sure that within the mechanical assembly tolerance, the force between the scrapper 115 and the membrane is uniform along the blade 117. For example, there are 3 springs, with a 500 um compression and the force is around 1N. To prevent the bubbles from sticking to the blade 117 and being pulled back to the printing area after the bubbles are pushed to the edge of the membrane, the membrane is framed into a shape with its two ends lifted up, so that the bubbles stay at the lifted area, 1 cm, when the scrapper 115 stops and returns to the other side of the membrane. The dual-roller spreader 113 linearly moves in one direction. For the same purpose of spreading the printing material in a thin layer, a rotary spreader 122 is also a solution (FIG. 5). In this configuration, the roller rotates around one point at the roller, typically the center point. When the roller rotates, the speed of each point various by:

V=ω*r

Here V is the linear velocity of a point, ω is the angular velocity of the rotation, r is the distance to the rotating axial point. This equation shows that at different point r the roller needs to rotate at different speed. Therefore, a solid roller is not applicable for a rotary roller as it will scratch the membrane. A differential is needed, in this case, multiple bearings are installed on a shaft to form the roller and each bearing is allowed to rotate at different speed since a small gap, e.g., a 20 um gap, separates the bearings from each other. The bearing itself still has certain thickness (>1 mm), hence there is still sliding friction to the membrane within one bearing during the roller rotation, even through it is much smaller than that of a solid bar roller. Furthermore, the displacement of the rotary spreader to clear the space for DLP projection or laser scanning costs more time than the linear dual-roller case. As a result, the rotary spreader is less efficient than the linear one.

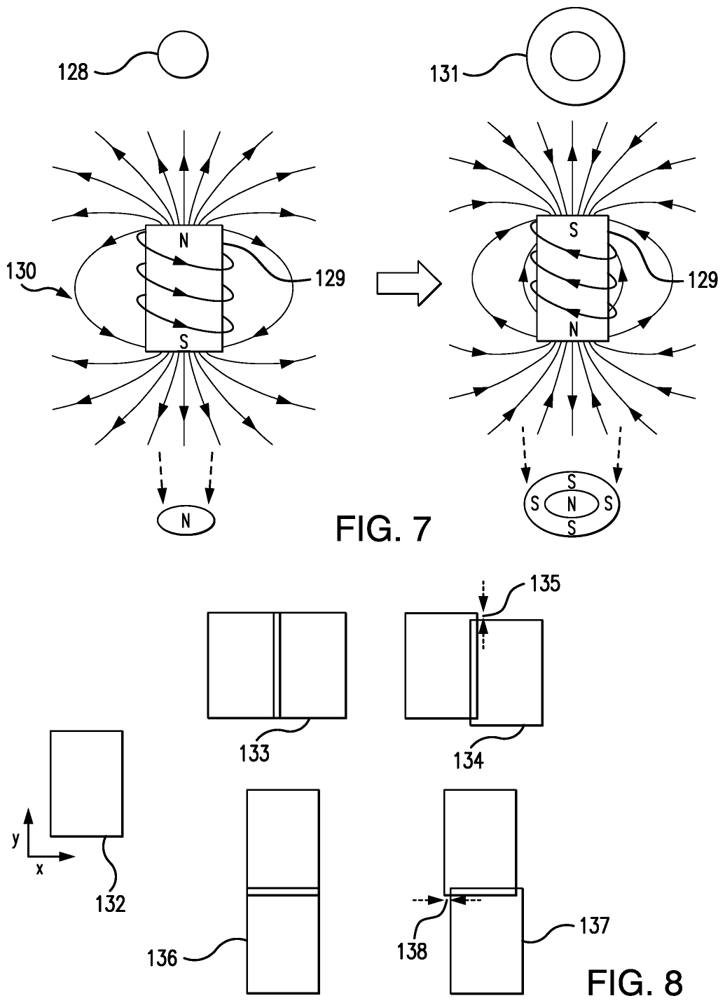

For the PμSL case, the printing process starts with generating a 3D model in the computer and then slicing the digital model into a sequence of images, wherein each image represents a layer (e.g., 5 to 20 micrometers) of the model. The control computer sends an image to the micro display chip, DLP or LCD, and the image is projected through the lens onto the bottom surface (the wet surface) of membrane. The bright areas of the projected image are polymerized whereas the dark areas remain liquid. As one layer is finished, the Z stage moves the sample substrate down about 3 mm to peel off the membrane from the sample. As soon as the membrane is separated from the sample, the sample again moves up to the flat membrane position less the thickness of current layer, during this movement, the dual-roller spreader oscillates on the membrane simultaneously to drive the resin away and flatten the membrane. In order to improve the printing speed, the range of the spreader oscillating adapts to the size of the sample, usually it is 1 cm more beyond the edge of the sample. At the same time, the laser displacement censor is reading the position of the membrane, when the reading of the membrane 126 reaches a nominal value within an acceptable tolerance (<25 um), the spreader 125 stops at one end of the membrane 126 to clear the space for the light exposure (FIG. 6), then the printer projects the layer image to solidify the shape of this layer. In the case of magnetic printing material (FIG. 7), before the light exposure, the magnetic dipoles are aligned with the magnetic field 130 created by the coaxial coil 129. The current of the coil 129, thus the magnetic field 130, is on for 1 to 2 seconds to let the magnetic dipoles to align with the excited field. After the dipole alignment, while keeping the current running, the printer starts to project the images and locks down the orientation of the dipoles in the areas defined by the image. If the next exposure is to define the dipoles with opposite orientation in different area of the same layer, the current in the coil is reversed for 1 to 2 s and then printer projects image of the next section with the current on. The above procedures are repeated for the number of the layers until the whole model is replicated in the resin vat with defined 3D magnetic distribution as needed.

Due to the size limit of either LCD or DLP chip, for example a DLP chip with 1920×1080 pixels at 10 um printing optical resolution, a single exposure will only cover area of 19.2 mm×10.8 mm. Therefore, if the cross-section of a sample is larger than 19.2 mm×10.8 mm, it cannot be printed with single exposure method. In the present invention, a multiple-exposure stitching printing method is provided. By this method, an image representing a layer of the 3D model is further divided into multiple smaller images with each image no larger than the DLP pixel resolution. For instance, an image of pixel resolution of 3800×2000 can be divided into four 1900×1000 sub-images with each one represents a quarter of this layer. As a result, a full layer of the model will be printed section by section based on the sub-images. To improve the mechanical strength of the shared edges of the adjacent sections, there is typically about a 5-20 micron overlap on the edges. The precise position and the amount of overlap are accurately controlled by the XY stage assembly. There are two coordinate systems: one is aligned with the DLP/LCD panel, the other one is the XY stage assembly. When these two coordinate systems are not parallel due to the assembly tolerance, there will be offset errors on the shared edges of adjacent sections. As shown in FIG. 8, 132 is the size of a single exposure; 133 is the result of precise alignment on x direction; 134 is the result with error offset on x direction 135; 136 is the result of precise alignment on y direction; 137 is the result with error offset on y direction 138. In precision printing, with error requirements less than 10 um, stage assembly tolerance is usually off the allowed range; and the offset is not linear to the stage travel distance. Therefore, in the invention, offsets are measured at 5 or more evenly distributed points on both x and y directions on the full-range printed square sample. The at least second order polynomial interpolated offset error curves will be fed into the translation of the XY stages to compensate the offset thus ensure the accuracy of the stitching-printed sample is within the specifications.

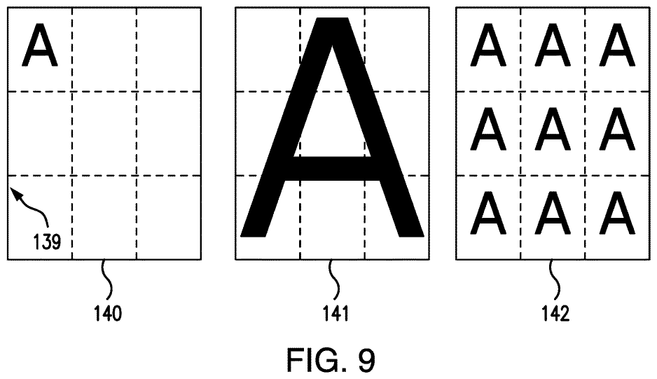

With the aid of the XY stages, the roller membrane layering provides basically three printing modes (FIG. 9). When printing a single sample, which is smaller than the single exposure size, the XY stages will not move during printing if only one printing material is needed in the exposure area. However, for a multi-material case, XY stages move to coat the selected resin. It is called single exposure mode 140. If multiple identical samples are needed, the XY states will move stepwise and print the same sample in an array. And this is called array exposure mode 142 which is must faster for small volume production than repeating the single exposure mode 140. As the sample size increases to exceed the size of the single exposure, the system will further divide one layer into multiple sections and stitch the adjacent sections into a whole layer by overlapping 5 um to 20 um on the shared edges. This is the stitching exposure mode 141. It is possible to combine the stitching mode 141 with array mode 142 when one needs multiple identical samples but needs stitching exposure 141 as the sample is larger than single exposure. However, this case is usually treated as stitching exposure mode 141.

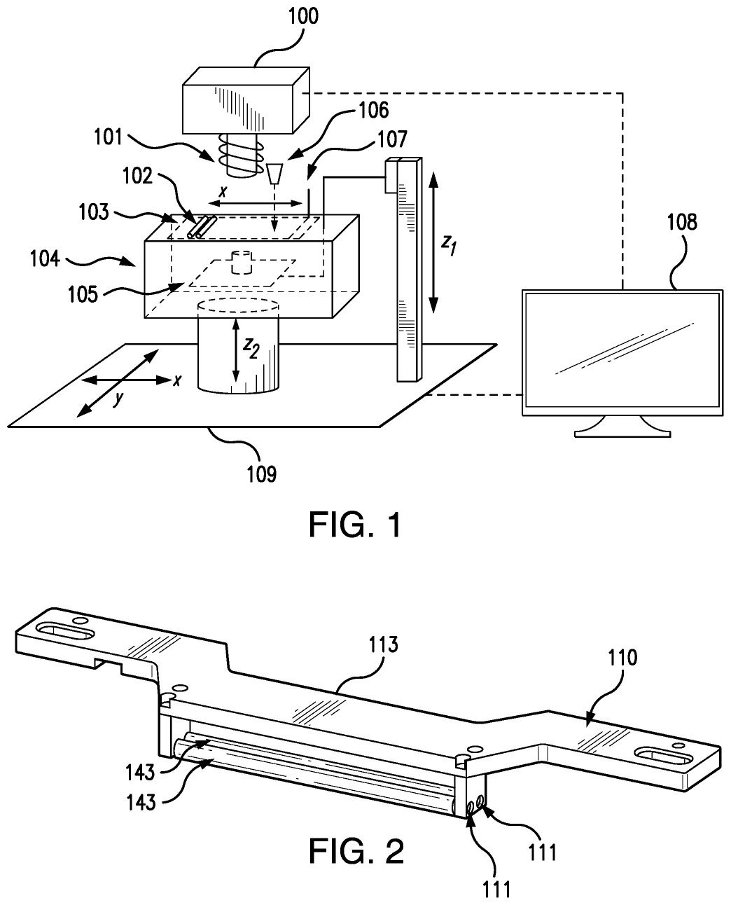

Referring now to FIG. 1, it shows a schematic drawing of a roller-membrane layering μSL system, including optical light engine 100, electromagnetic coil and lens 101, dual-roller spreader 102, membrane 103, resin vat 104, sample substrate 105, laser displacement sensor 106, bubble scrapper 107, control computer 108, and XYZ stage assembly 109. Referring now to FIG. 2, it shows a dual-roller spreader design in the roller-membrane system 113, including roller arm 110, bearings 111 and dual-rollers 143. Referring now to FIG. 3, it shows a schematic drawing of a dual-roller on membrane system, including sample substrate 112, dual roller spreader 113, clear membrane 114, bubble scrapper 115, and resin 121. Referring now to FIG. 4, it shows a bubble scrapper in a roller-membrane layering micro stereolithography system, including bubble scrapper 115, membrane 116, blade 117, spring 118, silicone tip 119, and blade arm 120. Referring now to FIG. 5, shown is a schematic drawing of a rotary-roller on a membrane system, including clear membrane 114, rotary spreader 122, bearings 123, bubble scrapper 115 and resin 121. Referring now to FIG. 6, it shows a printing sequence in the roller-membrane layering micro stereolithography system including steps (1-5), projection lens/coil 124, roller spreader 125, membrane 126, and resin 127. Referring now to FIG. 7, it shows steps of printing a 3D magnetic sample in the roller-membrane layering μSL system in Image 1, 128 and Image 2, 131, lens/coil 129 and magnetic field 130. Referring now to FIG. 8, shown is a stitching error in x and y directions during stitch printing in a roller-membrane layering the μSL system, including the size of a single exposure 132, the result of precise alignment on x direction 133, the result of precise alignment on y direction 136, 134 is the result with error offset on x direction 135, and 137 is the result with error offset on y direction 138. Referring now to FIG. 9, it shows three exposure modes in a roller-membrane layering μSL system, including single exposure 140 having printing boarders 139, stitching exposure 141, and array exposure 142.

1. A system for high resolution 3-D printing with higher printing speeds and greater of layer thickness, the system comprising:
i) an optical light engine, comprising a liquid crystal display (LCD) panel, a digital light processing (DLP) panel, or a laser beam with steering mirrors,
ii) a lens having an optical axis,
iii) an optically transparent membrane,
iv) a substrate for holding a printing sample,
v) a linear roller spreader or a rotary spreader on top of, and in contact with, the membrane,
vi) a bubble scrapper,
vii) three precision stages to control motion of the substrate for holding the sample or the printing projection system in X, Y, and Z directions,
viii) a resin vat for holding printing material below the membrane, and
ix) a laser displacement sensor positioned to monitor the membrane position and the printing substrate position and set to ensure one micron accuracy in positioning,
wherein the lens is situated between a surface of the sample, or the substrate for holding the sample, and the light engine, the membrane separates the linear or rotary roller spreader from the printing material in the resin vat and during printing the membrane contacts the printing material, the lens and the laser displacement sensor are gravitationally above the membrane, the substrate for holding the printing sample and the bubble scrapper are gravitationally below the membrane and submerged in the printing material in the resin vat, wherein the bubble scrapper physically contacts the membrane,
wherein the system controls layer thicknesses of the sample by printing layers of the sample while the membrane is contact with the printing material generating a layer in contact with the membrane, after a layer is printed the sample holder, and thus the sample thereon, are moved down and away from the membrane, peeling the membrane from the sample, and after the membrane is separated from the sample the sample holder and sample are moved back towards the membrane, while the dual-roller spreader or rotary roller spreader oscillates on the membrane to simultaneously to drive away printing material and flatten the membrane, wherein the movement of the sample substrate and sample toward membrane, and the oscillations of the roller spreader or rotary spreader on the membrane are stopped when a reading from the laser displacement sensor shows that the membrane and sample or sample substrate are positioned, within an acceptable tolerance, at a distance to define the thickness of the next layer to be formed.

2. The system of claim 1 wherein the lens having an optical axis further comprises an electromagnetic coil jacket to create a magnetic field at a printing area.

3. The system of claim 1 wherein the linear roller spreader is a dual-roller linear spreader.

4. The system of claim 3 wherein at least one roller of the dual roller spreader is composed of metal or ceramic.

5. The system of claim 4 wherein the metal or ceramic rollers are coated with a silicone or rubber.

6. The system of claim 1 wherein the iii) optically clear membrane is a PFA (PerFluoroAlkoxy) membrane or a FEP (Polyfluoroethylenepropylene) membrane.

7. The system of claim 1 wherein the vi) bubble scrapper, has an arm supporting a scrapper blade with a tip, wherein the tip of the blade is pushed against the membrane.

8. The system of claim 7 wherein the scrapper blade tip is silicone.

9. A method for high resolution multi-layer 3-D printing, wherein a 3-D sample is prepared on a sample holder immersed in a printing material under an optically clear membrane, the method providing greater accuracy in layer thickness and higher printing speeds, the method comprising the steps:
projecting an image of a sample layer, or a plurality of sub-images which together provide a layer, onto a surface of an optically transparent membrane, which side contacts a printing material to prepare a layer of the sample that is in contact with the membrane,
moving the sample holder and the sample thereon down and away from the membrane, peeling the membrane from the sample,
after the membrane becomes separated from the sample, moving the sample towards the membrane while oscillating the dual-roller spreader or rotary roller spreader oscillates on the membrane to simultaneously to drive away printing material and flatten the membrane
monitoring the position of the membrane with a laser displacement sensor
stopping the movement of the sample substrate and sample toward membrane, and stopping the oscillations of the roller spreader or rotary spreader on the membrane when a reading from the laser displacement sensor shows that the membrane and sample or sample substrate are positioned, within an acceptable tolerance, at a distance to define the thickness of the next layer to be formed,
projecting an image or sub-image from a light engine onto the surface of the optically clear membrane, which surface is in contact with the printing material, to prepare a layer from an image or a portion of a layer from a sub-image.

10. The method according to claim 9, wherein the optical light engine comprises a liquid crystal display (LCD) panel, a digital light processing (DLP) panel, or a laser beam with steering mirrors, and the image is obtained by generating a 3D model in a computer and then slicing the digital model into a sequence of images wherein each image represents a layer of the model, and sub-images are prepared by dividing images with a cross section larger than a single exposure from the light engine, wherein the images or sub-images are sent from the computer to the light engine.

11. The method according to claim 10 wherein the image is projected from the light engine and through a lens having an optical axis to the surface of the optically clear membrane.

12. The method according to claim 11 wherein the printing material is a magnetic printing material comprising magnetic dipoles and the lens having an optical axis further comprises an electromagnetic coil jacket to create a magnetic field at a printing area, the method comprising steps wherein before the light exposure, the magnetic dipoles are aligned with the excited magnetic field created by current running through the coaxial coil
then, after the dipole alignment and while keeping the current running, projecting the image or sub-image and locking down the orientation of the dipoles in the areas defined by the image or sub-image.

13. The method according to claim 12 wherein if a next exposure is to define the dipoles with an opposite orientation in different area of the same layer, the current in the coil is reversed for and then printer projects image of the next section with the current on.

14. The method according to claim 9 wherein the printing material is a resin.

15. The method according to claim 9 wherein the printing material is a light curable resin.

16. The method according to claim 9 wherein the layers produced are from 5 to 20 micrometers thick.

17. The method according to claim 9 wherein a single exposure creates a full sample layer.

18. The method according to claim 9 wherein a plurality of sub-images are needed to create a complete sample layer and an image of a full layer is divided into multiple sub-images.

19. The method according to claim 18 wherein there is a 5-20 micron overlap between one sub-image and an adjacent sub-image.
